(19) United States
(12) Patent Application Publication
(10) Pub. No.: US 2021/0275390 A1
(43) Pub. Date: Sep. 9, 2021

(54) COMPRESSION SLEEVE WITH VIBRATING UNITS

(71) Applicant: RAPID REBOOT RECOVERY PRODUCTS LLC, Lindon, UT (US)

(72) Inventors: Yu-Chi Hsueh, Xiamen (CN); David K. Johnson, Lindon, UT (US)

(21) Appl. No.: 17/194,080

(22) Filed: Mar. 5, 2021

Related U.S. Application Data
(60) Provisional application No. 62/985,525, filed on Mar. 5, 2020.

(51) Int. Cl. A61H 23/02

(52) U.S. Cl. CPC A61H 23/0263; A61H 2205/06; A61H 2201/5097; A61H 2201/0103; A61H 2205/10

(57) ABSTRACT

An apparatus for providing compression and vibration therapy to a body part can include a housing, a pump positioned in the housing, the pump configured to generate air pressure, a compression sleeve configured to at least partially surround the body part, the compression sleeve can include an inflatable chamber in fluid communication with the pump and can be configured to apply pressure to the body part in response to receiving air from the pump, and a vibrating unit configured to apply a vibration to the body part.

### CROSS-REFERENCE TO RELATED APPLICATION

This application is a non-provisional patent application of, and claims priority to, U.S. Provisional Patent Application No. 62/985,525 filed Mar. 5, 2020, and entitled “Compression Sleeve with Vibrating Units,” the disclosure of which is hereby incorporated by reference in its entirety.

### FIELD

The described embodiments relate generally to a device for providing physical therapy to a body part. More particularly, the present embodiments relate to a sleeve configured to perform compression therapy and vibration therapy on a body part.

### BACKGROUND

The circulatory system is responsible for delivering oxygen, nutrients, and hormones to every cell in the human body. Additionally, the circulatory system flushes the body of toxins by removing metabolic wastes such as carbon dioxide and lactic acid.

Compression therapy involves compressing or applying pressure to a portion of a specific body part or parts. Compression therapy can be used to enhance blood flow to specific parts of the body, encouraging the body to deliver more oxygen and nutrients to those areas, which in turn can speed up recovery, relieve pain, and improve athletic performance. The benefits of compression therapy include enhanced blood flow, reduced swelling and inflammation, faster muscle recovery, delayed-onset muscle soreness prevention, relieved muscle pain, improved athletic performance, increased flexibility and range of motion, removal of lactic acid, and decreased muscle fatigue.

Additionally, vibration or percussive therapy can be used to manipulate soft tissue to reduce muscle soreness and stiffness, and to increase range of motion. Vibration therapy can increase blood flow to the treated areas, increase skin temperature, reduce muscle inflammation, release muscle tension, break up muscle knots, and prevent delayed-onset muscle soreness (DOMS). Thus, there exists a demand for a device that offers dynamic compression and vibration therapy to provide enhanced physical therapy.

### SUMMARY

According to some examples of the present disclosure, an apparatus for providing compression and vibration therapy to a body part can include a housing, a pump positioned in the housing, the pump configured to generate air pressure, and a compression sleeve configured to at least partially surround the body part. The compression sleeve can include an inflatable chamber in fluid communication with the pump and can be configured to apply pressure to the body part in response to receiving air from the pump. The compression sleeve can also include a vibrating unit configured to apply a vibration to the body part.

In some examples, the vibrating unit is disposed inside the inflatable chamber. The vibrating unit can be configured to be pressed against the body part in response to the inflatable chamber being inflated. The vibrating unit can be secured to the compression sleeve using an adhesive. The vibrating unit can include an eccentric rotating mass vibration motor.

In some examples, the apparatus includes a user interface configured to control operation of the apparatus. The apparatus can include a wireless communications component configured to allow remote control of the apparatus. The compression sleeve can include a second inflatable chamber configured to operate independent of the inflatable chamber. The inflatable chamber can house the vibrating unit positioned on a first side of the inflatable chamber, and a second vibrating unit positioned on a second side of the inflatable chamber, the second side can be configured to be opposite the first side during operation of the apparatus.

In some examples, the pump can be coupled to a first end of a hose and the inflatable chamber can be coupled to a second end of the hose, the hose providing fluid communication between the pump and the inflatable chamber. Electrical wiring for the vibrating unit can pass through the hose. In some examples, the vibrating unit and the pump can be configured to operate simultaneously. Operation of the vibrating unit can be independent from operation of the inflatable chamber.

According to some examples of the present disclosure, a method for providing compression and vibration therapy to a body part is disclosed. The method can include providing a vibrating unit configured to apply vibrations to the body part, providing a compression sleeve configured to apply pressure to the body part, providing a pump in fluid communication with the compression sleeve, inflating the compression sleeve using the pump, and vibrating the body part using the vibrating unit. In some examples, the vibrating unit can disposed inside the compression sleeve.

According to some examples of the present disclosure, an apparatus for providing compression and vibration therapy to a body part includes a pump, an inflatable chamber in fluid communication with the pump and configured to inflate, and a vibrating unit configured to produce a vibrational force that is transferred to the body part. In some examples, the apparatus includes a compression sleeve configured to at least partially surround the body part, the compression sleeve including the inflatable chamber and the vibrating unit. The vibrating unit can be disposed inside the inflatable chamber.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a physical therapy system including a pump assembly and a compression sleeve.

FIG. 2A shows a front perspective view of the pump assembly.

FIG. 2B shows an interior of the compression sleeve including inflatable chambers and vibrating units.

FIG. 3 shows a perspective view of a vibrating motor.

FIG. 4 shows a perspective view of the vibrating motor of FIG. 3.

FIG. 5 shows an exploded view of a vibrating unit.

FIG. 6 shows the vibrating motor disposed within a top of the vibrating unit.

FIG. 7 shows a side view of the vibrating unit of FIG. 5.

FIG. 8 shows a side view of the vibrating unit of FIG. 5.

FIG. 9 shows a bottom perspective view of a base of the vibrating unit.

FIG. 10 shows a perspective view of the compression sleeve.

FIG. 11 shows connection elements for tubing and wiring.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Compression therapy involves applying pressure to a region of the body. Compression therapy can, among other things, be used to enhance blood flow to specific parts of the body, encouraging the body to deliver more oxygen and nutrients to those areas, which in turn can speed up recovery, relieve pain and improve athletic performance. Vibration or percussive therapy involves manipulating soft tissue with oscillating motions designed to massage, shake, vibrate, or repeatedly impact the body. Vibration therapy can, among other things, increase blood flow to the treated areas, increase skin temperature, reduce muscle inflammation, release muscle tension, break up muscle knots, and prevent delayed-onset muscle soreness (DOMS).

The following disclosure relates to an apparatus for applying physical therapy to a region of the body. More specifically, the following disclosure relates to a compression sleeve including inflatable chambers and vibrating units.

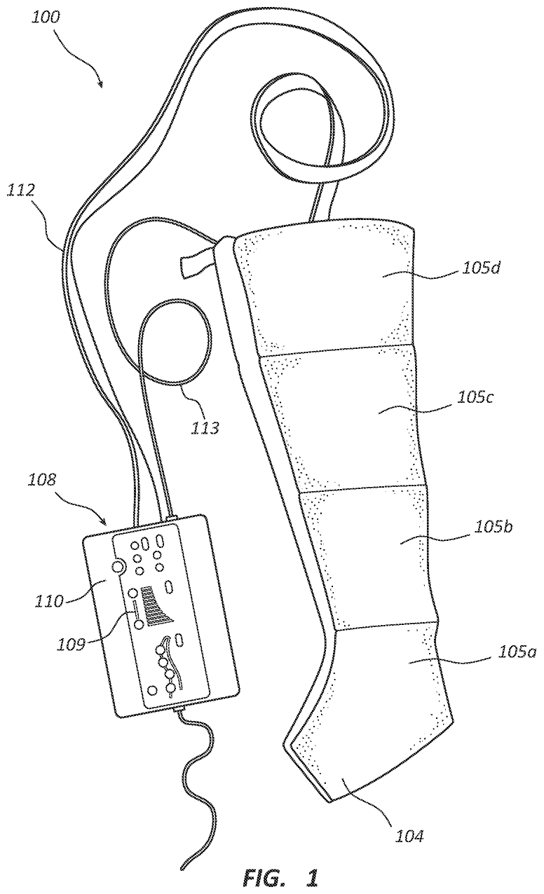

These and other embodiments are discussed below with reference to FIGS. 1-11. However, those skilled in the art will readily appreciate that the detailed description given herein with respect to these figures is for explanatory purposes only, and should not be construed as limiting.

FIG. 1 illustrates a physical therapy system 100 for delivering compression and vibration therapy to a body region of a wearer, such as a leg, arm, hip, shoulder, or torso. The system 100 can include a compression sleeve 104 and a pump assembly 108. The pump assembly 108 and the compression sleeve 104 can be in fluid communication by means of one or more hoses or tubing 112 and can also be in electrical communication by means of electrical wiring 113.

In some examples, the compression sleeve 104 can include a plurality of inflatable chambers or sections 105a, 105b, 105c, 105d (collectively 105). The inflatable chambers 105 can be defined by the fabric of the compression sleeve 104 and can be isolated from one another. In some examples, each chamber 105 is in fluid communication with the pump assembly 108 via a respective hose of the tubing 112.

The pump assembly 108 can be connected to a power source, such as a wall outlet, to power a pump motor (not shown). The pump assembly 108 can include a housing 110 and a DC motor positioned in the housing and configured to provide air pressure and vacuum. The pump assembly 108 can push air through the tubing 112 and into the compression sleeve 104. The pump assembly 108 can include batteries positioned in the housing 110, such as rechargeable batteries, to remotely power the motor. The electrical wiring 113 can be connected to the pump assembly 108 by means of any suitable electrical connection. In some examples, the electrical wiring 113 is incorporated into the tubing 112. For example, the electrical wiring 113 can be housed within the same mold that defines the tubing 112. The electrical wiring 113 can be fed through and disposed within a lumen or conduit of the tubing 112 itself. In some examples, the electrical wiring 113 is configured to run parallel to the tubing 112. For example, the tubing 112 and the covering for the electrical wiring 113 can be formed from the same mold. In some examples, the electrical wiring 113 is attached or adhered to the external surface of the tubing 112.

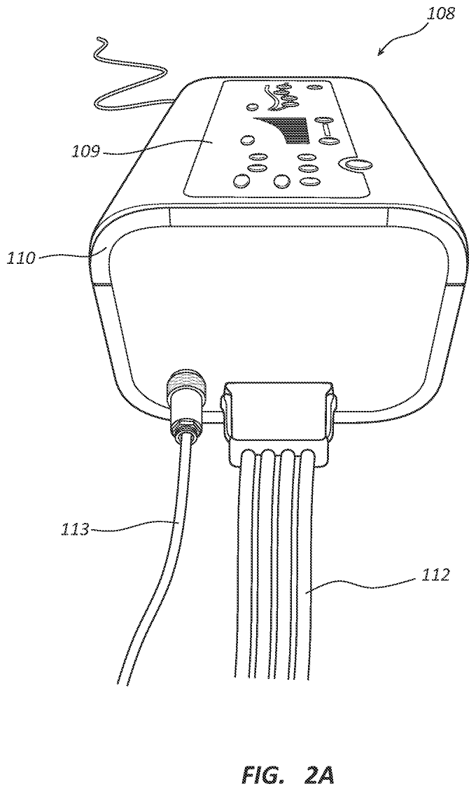

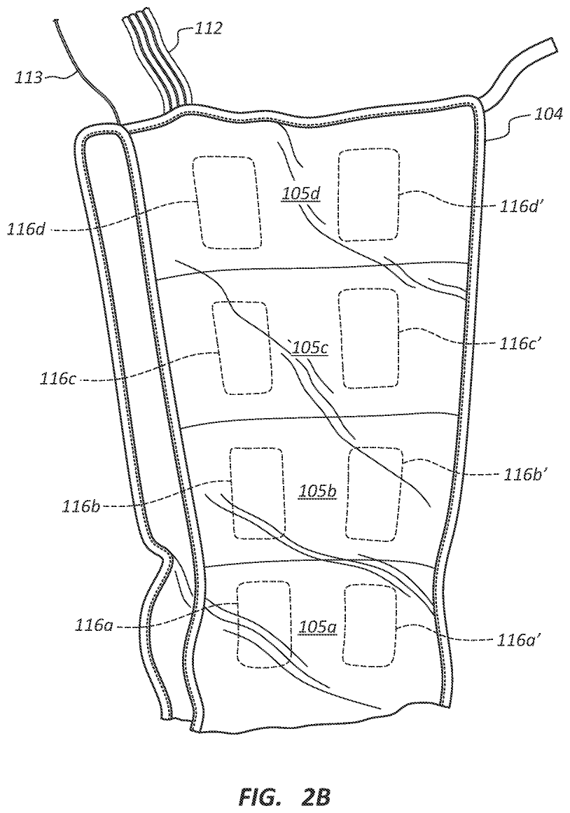

FIG. 2A illustrates a perspective view of the pump assembly 108 including tubing 112 and electrical wiring 113. In some examples, each inflatable chamber 105 is in fluid communication with the pump assembly 108 by means of an independent conduit or hose. For example, if the compression sleeve 104 includes four inflatable chambers 105, the tubing 112 could then include four independent tubes or conduits which lead to each of the inflatable chambers 105.

In some examples, the pump assembly 108 includes a processing unit (not shown) positioned within the pump housing 110 and a display 109 operationally coupled to the processing unit. In some examples, the display 109 can be positioned at least partially within the pump housing 110. The display 109 can define at least a portion of an exterior of the pump housing 110. The display 109 can be configured to display graphical-user interfaces executed by the processing unit.

The display 109 can be used to display a user interface associated with one or more programs executed on the processing unit. For example, the display 109 can display a control panel processing user interface, an instrument cluster user interface, a web browsing user interface, an infotainment interface, and so on.

The display 109 can be capable of presenting a user interface that includes icons (representing software applications), textual images, and/or motion images. In some examples, each icon can be associated with a respective function of the compression sleeve 104 that can be executed or adjusted by the processor. The display 109 can include a liquid-crystal display (LCD), light-emitting diode display (LED), organic light-emitting diode display (OLED), or the like. In some examples, the display 109 includes a touch input detection component and/or a force detection assembly that can be configured to detect changes in an electrical parameter (e.g., electrical capacitance value) when a user's appendage (acting as a capacitor) comes into proximity with the display 109 (or in contact with a transparent layer that covers the display 109). In some examples, the pump housing 110 includes buttons, switches, knobs, or other input mechanisms that can be manipulated by the user to adjust the operating parameters of the pump and compression sleeve 104.

In some examples, the user interface can be accessible on an electronic device, such as a smartphone, tablet, or computer. The processor can include a wireless communications component. A network/bus interface can couple the wireless communications component to the processor. The wireless communications component can communicate with electronic devices (e.g., smartphone, smartwatch, tablet, laptop, desktop) through any number of wireless communication protocols, including at least one of a global network (e.g., the Internet), a wide area network, a local area network, a wireless personal area network (WPAN), or the like. In some examples, the wireless communications component can transmit data to the other electronic devices over IEEE 802.11 (e.g., a Wi-Fi® networking system), Bluetooth (IEEE 802.15.1), ZigBee, Wireless USB, Near-Field Communication (NFC), a cellular network system (e.g., a 3G/4G/5G network such as UMTS, LTE, etc.), or the like.

In some exemplary embodiments, the components and functions described herein as being included in the pump assembly 108 can independently be located or distributed in other locations of the physical therapy system 100. For example, according to one alternative embodiment, power supplies, wireless communication components, control systems, and/or other functional elements can be locally distributed throughout the physical therapy system 100 for added convenience, increased functionality, and/or fit.

In some examples, the system 100 can include thermal therapy systems, such as thermotherapy (heat) and cryotherapy (cold). Cold treatment can reduce inflammation by decreasing blood flow. Heat treatment can promote blood flow and help muscles relax. Alternating heat and cold may help reduce exercise-induced muscle pain. The thermal therapy system can be configured to work in concert with the pump or independently. For instance, the thermal therapy system can be configured to provide heat and/or cold to an inflated chamber 105. In some examples, the thermal therapy system continuously provides heat and/or cold, regardless of the air pressure within the compression sleeve 104.

In some examples, the compression sleeve 104 can include electrical heating wires (not shown) that heat up when provided with electricity. The heating wires can run throughout the compression sleeve 104, either inside or exterior to the compression sleeve 104. The system 100 can include a control unit for controlling the temperature of the heating wires.

In some examples, the pump assembly 108 can be configured to heat and/or cool the air that is being provided to the inflatable chambers 105. In this manner, the chambers 105 can transfer heat and/or cold to the user's limb when inflated. In some examples, liquids or gels can be used to provide thermal therapy to the body part. The liquids or gels can be circulated throughout portions of the compression sleeve 104. In some examples, the pump assembly 108 is configured to circulate the liquids or gels in addition to air via separate tubing. In some examples, instead of providing pressure by means of air, the pump assembly 108 is configured to circulate the liquids or gels to pressurize the compression sleeve. In this manner, the compression therapy and also the thermal therapy can be accomplished with a single system.

FIG. 2B illustrates the compression sleeve 104 in an open configuration with the interior of the compression sleeve 104 exposed. In some examples, the compression sleeve 104 can include fastening means (not shown), such as zippers, buttons, snaps, latches, Velcro, laces, or any other suitable fastening means that can be positioned along the length of the compression sleeve 104. The fastening means can be loosened or undone to open the compression sleeve 104 and attached or secured to close/seal the compression sleeve 104. In some examples, the compression sleeve 104 includes a zipper that runs along at least a portion of the length of the compression sleeve 104. When unzipped the compression sleeve 104 can be opened to more easily receive a body part of the user, such as an arm or leg. The zipper can then be this zipped-up to secure the limb within the compression sleeve 104.

As illustrated in FIG. 2B, the compression sleeve 104 can include a plurality of vibrating units 116a, 116a′, 116b, 116b′, 116c, 116c′, 116d, 116d′ (collectively 116) (outlined in black rectangles for emphasis). The vibrating units 116 can be attached to the compression sleeve 104 and can each correspond to a respective inflatable chamber 105 of the compression sleeve 104. In some examples, the inflatable chambers 105 can house the vibrating units 116. In other words, the vibrating units 116 can be disposed within the inflatable chambers 105. More than one vibrating unit 116 can be disposed within an inflatable chamber 105. For example, inflatable chamber 105a can house vibrating units 116a and 116a′, inflatable chamber 105b can house vibrating units 116b and 116b′, inflatable chamber 105c can house vibrating units 116c and 116c′, and inflatable chamber 105d can house vibrating units 116d and 116d′. The two vibrating units 116 of each chamber 105 can be located on opposite sides of the user's limb when the compression sleeve 104 is closed. The position of the vibrating units 116 can depend on the chamber 105a in which they are located. For example, vibrating units 116a and 116a′ located in chamber 105a can be proximate a foot of the user while vibrating units 116d and 116d′ located in chamber 105d can be proximate a thigh of the user. As such, the position of vibrating units 116a and 116a′ in chamber 105a can be different from the position of vibrating units 116d and 116d′ in chamber 105d to best suit that particular region of the body.

As discussed above, if the compression sleeve 104 includes four inflatable chambers 105, the tubing 112 could then include four independent tubes or conduits which lead to each of the inflatable chambers 105. In some examples, the electrical wiring 113 can be incorporated into the tubing 112. For example, wires can be fed through each of the isolated conduits of the tubing 112 to connect to respective vibrating units 116. In examples where each inflatable chamber 105 houses two vibrating units 116, there can be two wire groups fed through each hose or conduit. To ensure that the airflow within the tubing 112 is not overly restricted by the incorporated wires, the dimensions of the tubing 112 can be adjusted to allow for sufficient airflow while still accommodating the electrical wiring 113. Feeding the electrical wiring 113 through the tubing 112 improves the aesthetics of the device and also provides additional protection to the electrical wiring 113.

The vibrating units 116 can be substantially similar to one another. In some examples, the operating parameters of the vibrating units 116 can differ. For instance, the operating parameters of the vibrating units 116 can differ depending on their location. The vibrating units 116 can be attached to a wall or section of their respective inflatable chamber 105. For example, the vibrating units 116 can be adhered or affixed to the interior fabric of the inflatable unit using an adhesive. Other methods of securing the vibrating units 116 in place can also be implemented. For instance, the vibrating unit can be secured in a pocket or pouch that is designed (e.g., sewn) directly into the fabric of the compression sleeve 104. In some examples, the vibrating units 116 can include an attachment mechanism configured to couple with a corresponding attachment mechanism integrated into the compression sleeve 104.

The vibrating units 116 can be positioned adjacent to or proximate with the limb of the user, such that when an inflatable chamber 105 is inflated, the respective vibrating units 116 are pressed against the user's limb. In some examples, the vibrating units 116 can be disposed on an exterior of the inflatable chambers 105. For example, the vibrating units 116 can be positioned in between inflatable chambers 105 or positioned on an exterior of the inflatable chambers 105, such that the vibrating unit 116 is immediately adjacent to the user's limb.

In some examples, the vibrating units 116 can be configured to operate independent of the pump. For example, the vibrating units 116 can be programmed to remain active even if their respective chamber 105 is not inflated. In some examples, the vibrating units 116 can follow a programming schedule that is linked to an inflation schedule. For instance, the vibrating units 116 corresponding to a particular chamber 105 can be configured to activate only when that chamber 105 is inflated. The user can fully customize the operation of the vibrating units by adjusting the pattern, schedule, and operating parameters of the vibrating units. This customization can be done through a user interface (“UI”) on the pump housing 110 or via a Bluetooth connection (e.g., on a smartphone app).

In some examples, the vibrating units 116 can be operated via wireless connection. The vibrating units 116 can be communicatively connected to the UI of the pump assembly 108 or a user's smart device. In some examples, a rechargeable battery can be incorporated into the sleeve 104 to power the vibrating units 116 while being removed from an external power source. In some examples, each of the vibrating units 116 include batteries, such as rechargeable batteries, to allow the vibrating units 116 to operate while being removed from an external power source. In some examples, the system 100 includes a plurality of pumps (not shown). One or more pumps can be in fluid communication with one or more chambers 105, for example, the pumps can be incorporated into the sleeve 104 itself. The pumps can include a remote power supply, such as a rechargeable battery that is incorporated into the sleeve. In this way, the compression sleeve 104 can provide compression and vibration therapy without having to be connected to an external pump or external power source.

In some examples, a wireless communications component, such as a wireless receiver can be incorporated into the sleeve 104. The wireless communications component can communicate with electronic devices (e.g., smartphone, smartwatch, tablet, laptop, desktop) through any number of wireless communication protocols, including at least one of a global network (e.g., the Internet), a wide area network, a local area network, a wireless personal area network (WPAN), or the like. The wireless communications component can be configured to communicate with a localized power supply on the sleeve 104, as discussed above.

FIGS. 3 and 4 illustrate front and rear perspective views of an example of a vibrating motor 120 that can be used in the vibrating units 116. In some examples, the vibrating motor 120 can be an eccentric rotating mass vibration motor (ERM) including an unbalanced mass 122 on a DC motor. In some examples, the vibrating unit can include a linear resonant actuator (LRA) (not shown) that includes a small internal mass attached to a spring, which creates a force when driven. It will be understood that other types of vibrating motors can be used and that any means of creating a vibrational force are also herein contemplated for use with the compression sleeve 104, including, but in no way limited to, coin vibration motors (also called flat vibration motor), surface mount device (SMD) reflow solderable vibration motors, linear resonant actuators (LRA's), piezoelectric motors, and cylinder coreless motors.

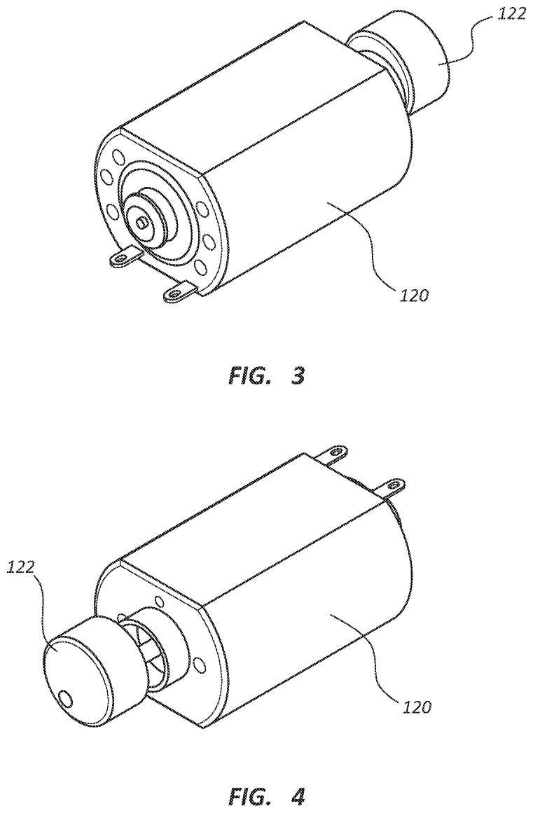

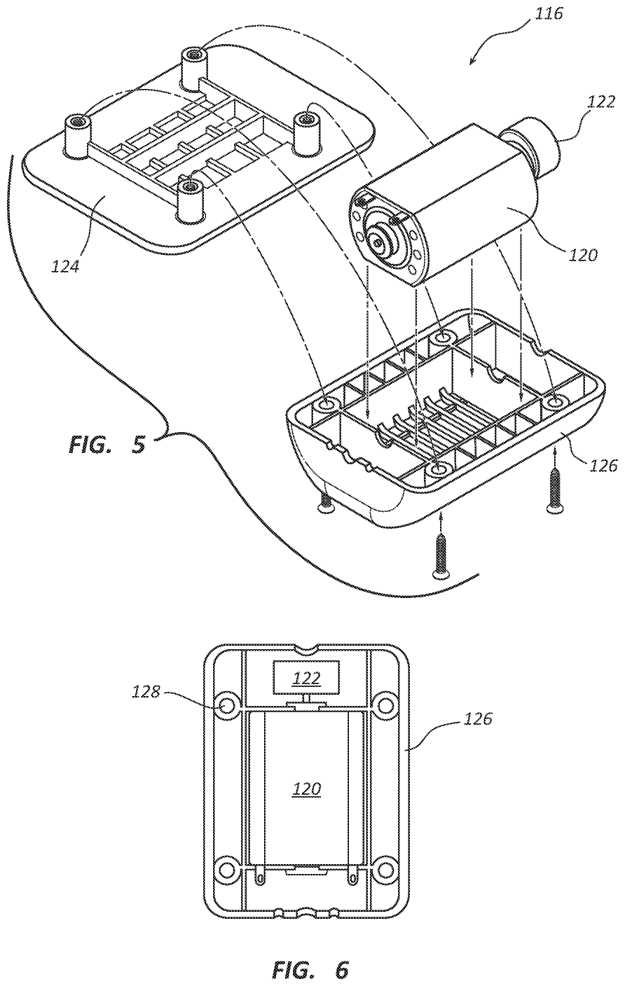

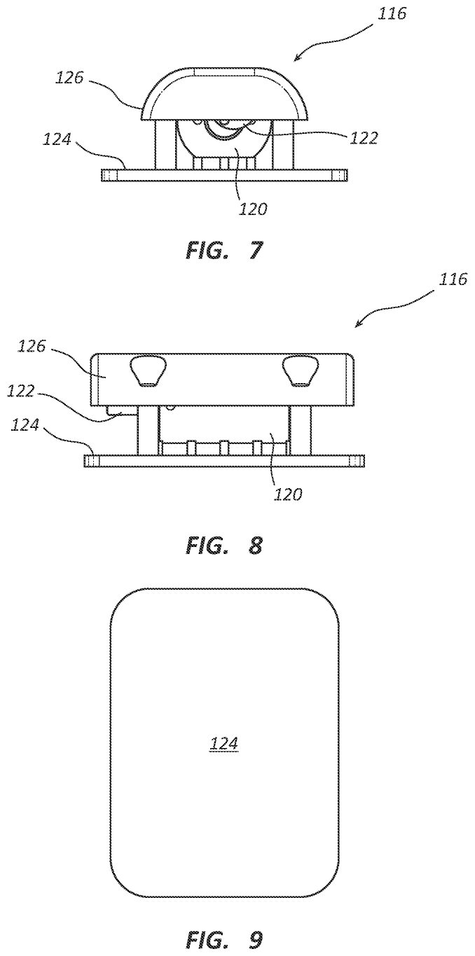

FIG. 5 illustrates an exploded view of an example vibrating unit 116. The vibrating unit 116 can include a base 124, a motor 120, and a top 126. In some examples, the motor 120 can be securely positioned between the base 124 and the top 126. The base 124 and top 126 can be coupled using any suitable coupling means, such as threaded screws. As illustrated in FIG. 6, the top 126 can be shaped to closely receive the motor 120. The top 126 can define a space configured to receive the unbalanced mass 122 and to allow the unbalanced mass 122 to freely rotate without contacting any part of the top 126 or base 124. For example, FIGS. 7 and 8 show front and side views of the vibrating unit 116 in an assembled state.

FIG. 9 illustrates a bottom perspective view of the base 124. The bottom of the base 124 can include a smooth planar surface. In some examples, the smooth planar surface of the base 124 is adhered to the compression sleeve 104. The base 124 can be adhered to the compression sleeve 104 by any appropriate adhesion method including, but not limited to, and adhesive, fasteners, an interference retention system (such as a pocket or tab), stitching, thermos-welding, or ultrasonic welding. The shape of the bottom of the base 124 can be configured to provide a comfortable contact between the vibrating unit 116 and the user's limb. To maximize vibrational transfer, the bottom of the base 124 can be shaped and positioned to allow substantially all of the surface area of the bottom of the base 124 to be pressed against the limb of the user.

In some examples, the bottom of the base 124 can be include a heating element. By positioning a heating element on the bottom of the base 124, the transfer of thermal energy can be increased because the bottom of the base 124 is designed to be pressed against the user's limb.

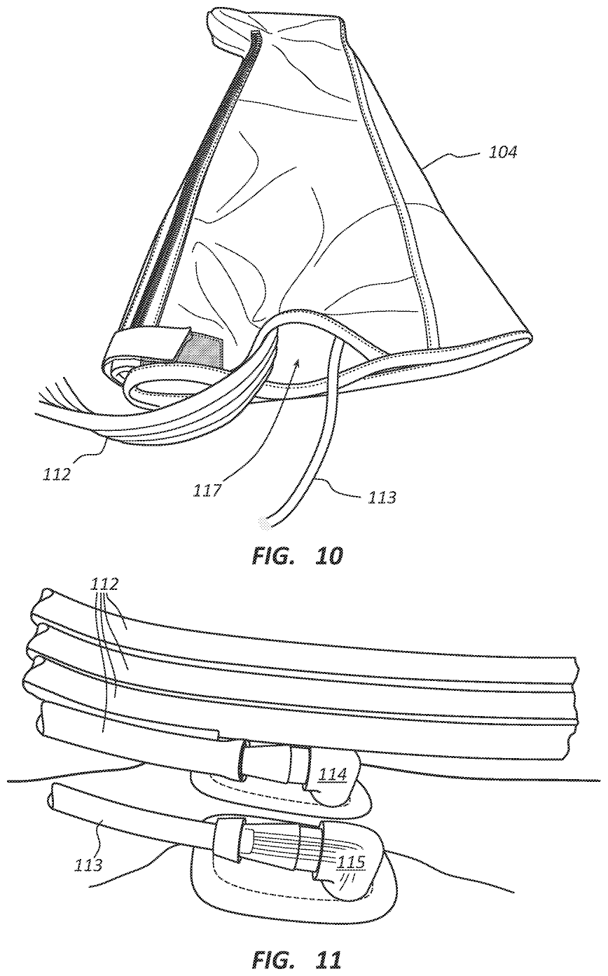

FIG. 10 illustrates a perspective view of the compression sleeve 104 with tubing 112 and electrical wiring 113 being fed through an opening 117 in the side of the compression sleeve 104. The opening 117 can lead to an outer flap that covers connection points between inflatable chambers 105 and tubing 112 and electrical wiring 113. As shown, the electrical wiring can be inserted into the opening 117 and the electrical wiring 113 can be led or distributed to any number of functional components disclosed herein (vibration motors, heating elements, etc.).

FIG. 11 illustrates a connector 114 and a protective guide 115. In some examples, the electrical wiring can be inserted into the chamber through the tubing 112, where it can be connected to a vibrating motor 120 without impacting the structural integrity of the chamber. The connector 114 can be incorporated into the fabric of the compression sleeve 104 and can fluidly connect the tubing 112 with an inflatable chamber 105. The protective guide 115 can be incorporated into the fabric of the compression sleeve 104 and can shield the electrical wiring 113 as is passes through the compression sleeve to connect with the vibrating unit 116, thereby providing a protective pathway through which wires 113 travel.

In some examples, the vibrating units 116 can be used to notify the user of various operating conditions of the system. For example, specific vibrating units 116 can begin to pulse on and off in a distinct pattern to alert the user to an operating mode, for instance, that a particular chamber 105 of the compression sleeve 104 is about to inflate or deflate. Additionally, the vibrating units 116 can be activated to denote a period of time has passed, to loosen or provide impact therapy to an identified location, to signal a received signal, to signal an end to therapy, and the like.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An apparatus for providing compression and vibration therapy to a body part, the apparatus comprising:
a housing;
a pump positioned in the housing and configured to generate air pressure;
a compression sleeve configured to at least partially surround the body part, the compression sleeve comprising:
an inflatable chamber in fluid communication with the pump and configured to apply pressure to the body part in response to receiving air from the pump; and
a vibrating unit configured to apply a vibration to the body part.

2. The apparatus of claim 1, wherein the vibrating unit is disposed inside the inflatable chamber.

3. The apparatus of claim 1, wherein the vibrating unit is configured to be pressed against the body part in response to the inflatable chamber being inflated.

4. The apparatus of claim 1, wherein the vibrating unit is secured to the compression sleeve using an adhesive.

5. The apparatus of claim 1, wherein the vibrating unit comprises an eccentric rotating mass vibration motor.

6. The apparatus of claim 1, further comprising a user interface configured to control operation of the apparatus.

7. The apparatus of claim 1, further comprising a wireless communications component configured to allow remote control of the apparatus.

8. The apparatus of claim 1, wherein the compression sleeve comprises a second inflatable chamber configured to operate independent of the inflatable chamber.

9. The apparatus of claim 7, wherein the wireless communications component is disposed on the compression sleeve.

10. The apparatus of claim 7, further comprising a power supply disposed on the compression sleeve.

11. The apparatus of claim 1, wherein the inflatable chamber houses the vibrating unit positioned on a first side of the inflatable chamber, and a second vibrating unit positioned on a second side of the inflatable chamber, the second side configured to be opposite the first side during operation of the apparatus.

12. The apparatus of claim 1, wherein the pump is coupled to a first end of a hose and the inflatable chamber is coupled to a second end of the hose, the hose providing fluid communication between the pump and the inflatable chamber.

13. The apparatus of claim 12, wherein electrical wiring for the vibrating unit passes through the hose.

14. The apparatus of claim 1, wherein the vibrating unit and the pump are configured to operate simultaneously.

15. The apparatus of claim 1, wherein operation of the vibrating unit is independent from operation of the inflatable chamber.

16. A method for providing compression and vibration therapy to a body part, the method comprising:
providing a vibrating unit configured to apply vibrations to the body part;
providing a compression sleeve configured to apply pressure to the body part;
providing a pump in fluid communication with the compression sleeve;
inflating the compression sleeve using the pump; and
vibrating the body part using the vibrating unit.

17. The method of claim 16, wherein the vibrating unit is disposed inside the compression sleeve.

18. An apparatus for providing compression and vibration therapy to a body part, the apparatus comprising:
a pump;
an inflatable chamber in fluid communication with the pump and configured to inflate; and
a vibrating unit configured to produce a vibrational force that is transferred to the body part.

19. The apparatus of claim 18, further comprising a compression sleeve configured to at least partially surround the body part, the compression sleeve comprising the inflatable chamber and the vibrating unit.

20. The apparatus of claim 18, wherein the vibrating unit is disposed inside the inflatable chamber.
